(19) United States
(12) Patent Application Publication
(10) Pub. No.: US 2015/0069853 A1
(43) Pub. Date: Mar. 12, 2015

(54) INDUCTOR AND SWITCHING CIRCUIT INCLUDING THE SAME

(71) Applicant: Delta Electronics (Shanghai) CO., LTD., Shanghai (CN)

(72) Inventors: Zhaohui WANG, Shanghai (CN); Jiang CHU, Shanghai (CN); Zhi HUANG, Shanghai (CN)

(21) Appl. No.: 14/475,205

(22) Filed: Sep. 2, 2014

(30) Foreign Application Priority Data
Sep. 9, 2013 (CN) 201310407672.X

(51) Int. Cl. H01F 27/24; H02M 1/14

(52) U.S. Cl. CPC H01F 27/24; H02M 1/14; H02M 2001/0048
USPC 307/104; 336/178

(57) ABSTRACT

The present disclosure provides an inductor and a switching circuit including the inductor. The inductor at least includes a winding, and a magnetic core which includes one or more limbs and further includes one or more yokes adapted to form a closed magnetic path, the winding being wounded on the limbs. A gap is provided between at least one end of at least one of the limbs and at least one of the yokes, a flat magnetic core unit is provided in the gap, the flat magnetic core unit is formed of a material having a high permeability and a low saturation magnetic flux density, the limbs and yokes are formed of a material having high permeability and high saturation magnetic flux density, and the saturation magnetic flux density of the material of the flat magnetic core unit is lower than that of the material of the limbs and yokes.

### CROSS-REFERENCE TO RELATED APPLICATIONS

This application claims priority under 35 U.S.C. §119 to Chinese Patent Application No. 201310407672.X, filed on Sep. 9, 2013, the entire contents of which are incorporated herein by reference.

### TECHNICAL FIELD

The present disclosure relates to an inductor and a switching circuit including the inductor.

### BACKGROUND

At present, different kinds of inductors are widely applied in various circuits, for example, inductors used at a Direct Current (DC) side and an Alternating Current (AC) side in rectifying input circuits and DC inverter circuits, inductors used in switching conversion circuits such as DC conversion circuits (for example, Buck circuits and Boost circuits and so on), etc. Usually, when an inductor is used, it is usually required to maintain inductance as stable as possible within a rated range, at least not lower than minimum inductance requirements. It is found in actual use that an increased inductance may better suppress current spike, reduce current ripple and decrease circuit loss. However, if a large inductance is maintained from a light load current to a rated current, costs for manufacturing an inductor will rise, and a volume of the inductor will be increased. Thus, under a constant volume, increasing the inductance in the case of a light load current and meanwhile maintaining the inductance constant in the case of a rated current becomes a trend for manufacturing inductors now.

In conventional technologies, an inductor may be manufactured by many methods. FIG. 1 illustratively shows a structural diagram of a common inductor in conventional technologies. The inductor includes a yoke 1 and a limb 3 which form a closed path and constitute a magnetic core of the inductor. The magnetic core has an EI type structure. The inductor further includes a winding 2 of coils wounded on the limb 3, and an air gap 4 exists between the yoke 1 and the limb 3. A material of the magnetic core of such inductor (i.e., a material of the limb and the yoke) is a material having a high permeability. There is an air gap in the magnetic core. The inductance within a rated current range is linear, but the inductance will decline sharply after saturation of magnetic field.

To solve this problem, another inductor is proposed in conventional technologies, as shown in FIG. 2. A step 5 is included in the center of the limb 3 of the inductor. Because of the existence of the step, the air gap between the yoke 1 and the limb 3 has two widths. Such inductor generates a non-linear inductance. However, such inductor has defects that once the magnetic core in the step portion is saturated, the inductance will decline sharply, even lower than the inductance of a common inductor under a certain current, which will on the contrary result in deteriorated current waveforms, and that the manufacture process of such inductor is complicated.

FIG. 3 illustratively shows a structural diagram of another inductor proposed in conventional technologies. This inductor employs a mixture manufacturing process of a magnetic core having a high permeability and a magnetic core having a low permeability. As shown in FIG. 3, a second magnetic core 6 made of a material having a low permeability fills the air gap between the yoke 1 and the limb 3. The permeability of the magnetic core composed of the limb 3 and the yoke 1 is ten times or more of the permeability of the second magnetic core 6, and the second magnetic core 6 has a relatively high magnetic saturation, higher than 450 mT. Such inductor has a defect that a relatively large amount of the material having a low permeability of the magnetic core is needed during manufacturing, which results in additional costs. The magnetic core shown in FIG. 3 has an EI structure, and the magnetic core 6 fills, at the center portion of the central magnetic core, the air gap between the limb 3 and the yoke 1. The same design may also be applied to the case where the magnetic core has a UI structure. As shown in FIG. 4, the magnetic core 6 fills, at both ends of the limb 3, the air gap between the limb 3 and the yoke 1.

Thus, a novel design of inductor product which may reduce coil loss, provide a non-linear inductance, and have a simple manufacturing process and low costs is needed.

### SUMMARY OF THE INVENTION

One object of the present disclosure is to provide an inductor which may provide a non-linear inductance, may improve non-linear inductance graphs by adjusting a thickness and a cross sectional area of a material having a high permeability and a low saturation magnetic flux density, and meanwhile may lower costs and reduce eddy-current loss in coils.

In order to achieve the above object, the present disclosure employs the following technical solutions.

The present disclosure provides an inductor, which at least includes a winding, and a magnetic core which includes one or more limbs and further includes one or more yokes adapted to form a closed magnetic path. The winding is wounded on the limbs. A gap is provided between at least one end of at least one of the limbs and at least one of the yokes, a flat magnetic core unit is provided in the gap, the flat magnetic core unit is formed of a material having a high permeability and a low saturation magnetic flux density, the limbs and the yokes are formed of a material having a high permeability and a high saturation magnetic flux density, and the saturation magnetic flux density of the material of the flat magnetic core unit is lower than that of the material of the limbs and the yokes.

According to an embodiment, the gap may be provided between two ends of at least one of the limbs and at least one of the yokes, and the flat magnetic core unit formed of the material having a high permeability and a low saturation magnetic flux density may be provided in the gap.

According to an embodiment, cross sectional projection of the flat magnetic core unit may contain cross sectional projection of an end of at least one of the limbs.

According to an embodiment, a cross sectional projection of the flat magnetic core unit may contain cross sectional projection of ends of at least one of the limbs and the winding.

According to an embodiment, the flat magnetic core unit may be provided at an end of the gap which is close to at least one of the limbs.

According to an embodiment, the flat magnetic core unit may be manganese zinc ferrite or nickel zinc ferrite.

According to an embodiment, a portion of the gap other than the flat magnetic core unit may be filled with an insulating material.

According to an embodiment, the materials of the one or more limbs, the one or more yokes and the flat magnetic core unit have a relative permeability greater than or equal to 500.

According to an embodiment, the saturation magnetic flux density of the material of the one or more limbs and the one or more yokes may be twice or more of the saturation magnetic flux density of the material of the flat magnetic core unit.

According to an embodiment, the saturation magnetic flux density of the material of the one or more limbs and the one or more yokes may be greater than or equal to 1.2 T, and the saturation magnetic flux density of the material of the flat magnetic core unit may be less than or equal to 0.6 T.

According to an embodiment, the magnetic core may have an EI type structure or a UI type structure.

According to an embodiment, the magnetic core has a three-phase three-limb structure or a three-phase five-limb structure.

The present disclosure further provides a switching circuit including any one of the above inductors in which the inductor is connected to an input terminal or an output terminal of the switching circuit.

According to an embodiment, the switching circuit may include a rectifying circuit, an inverter circuit or a direct current conversion circuit.

According to an embodiment, the switching circuit may include a single-phase circuit or a three-phase circuit.

As compared with conventional technologies, the inductor and the switching circuit proposed by the present disclosure are capable of providing a non-linear inductance and meanwhile lowering costs and reducing eddy-current loss in coils.

### BRIEF DESCRIPTION OF THE DRAWINGS

FIG. 1 illustratively shows a schematic side view of an inductor structure in conventional technologies;

FIG. 2 illustratively shows a schematic side view of another inductor structure in conventional technologies;

FIG. 3 illustratively shows a schematic side view of another inductor structure in conventional technologies;

FIG. 4 illustratively shows a schematic side view of another inductor structure in conventional technologies;

FIG. 5 illustratively shows a schematic side view of an inductor structure according to a first embodiment of the present disclosure;

FIG. 6 illustrates graphs showing inductances of the inductor structure of the first present embodiment and a common inductor structure versus current changes;

FIG. 7 illustrates graphs showing the inductance of the inductor structure of the first present embodiment versus current changes in the case of different thicknesses of a flat magnetic core unit;

FIG. 8 is a schematic diagram of magnetic field lines of the inductor structure as shown in FIG. 4;

FIG. 9 is a schematic diagram of magnetic field lines of the inductor structure as shown in FIG. 5;

FIG. 10 illustratively shows a schematic side view of an inductor according to a second embodiment of the present disclosure;

FIG. 11 is a schematic diagram of magnetic field lines of the inductor structure as shown in FIG. 10;

FIG. 12 illustratively shows a schematic side view of another inductor structure according to the second embodiment of the present disclosure; and

FIG. 13 illustratively shows a schematic side view of another inductor structure according to a third embodiment of the present disclosure.

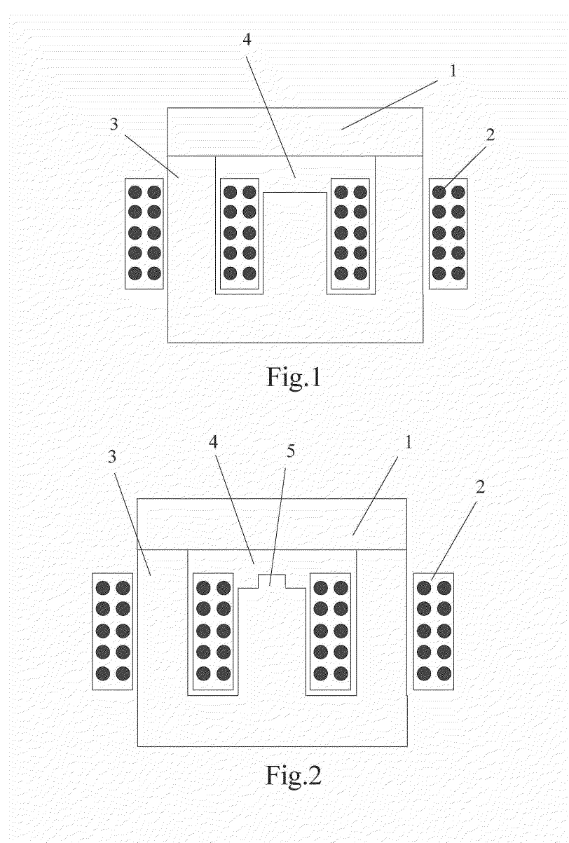

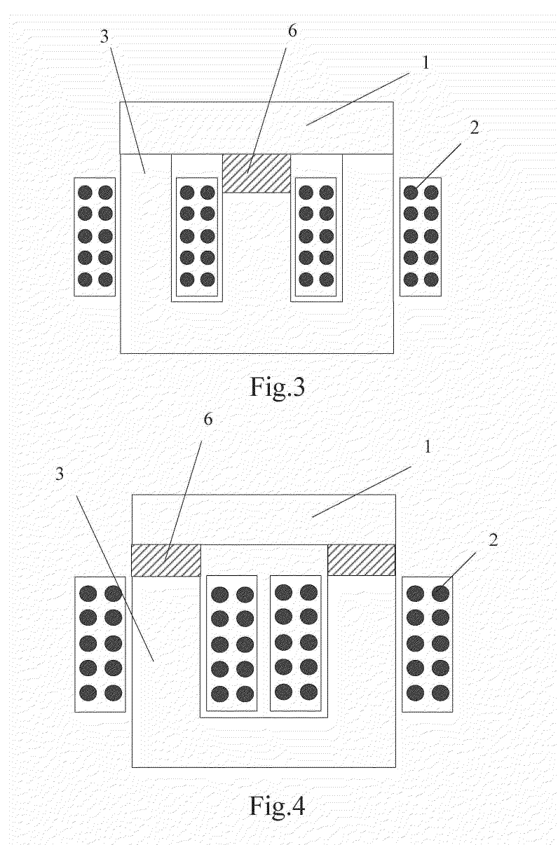

### DESCRIPTION OF THE EMBODIMENTS

Detailed description of the present disclosure will be made with reference to drawings and embodiments. It shall be appreciated that the embodiments described herein are for the purposes of illustration but not to limit the present disclosure. In addition, it shall be noted that only the parts related to the present disclosure but not all the structures are shown in the drawings for the convenience of description.

### First Embodiment

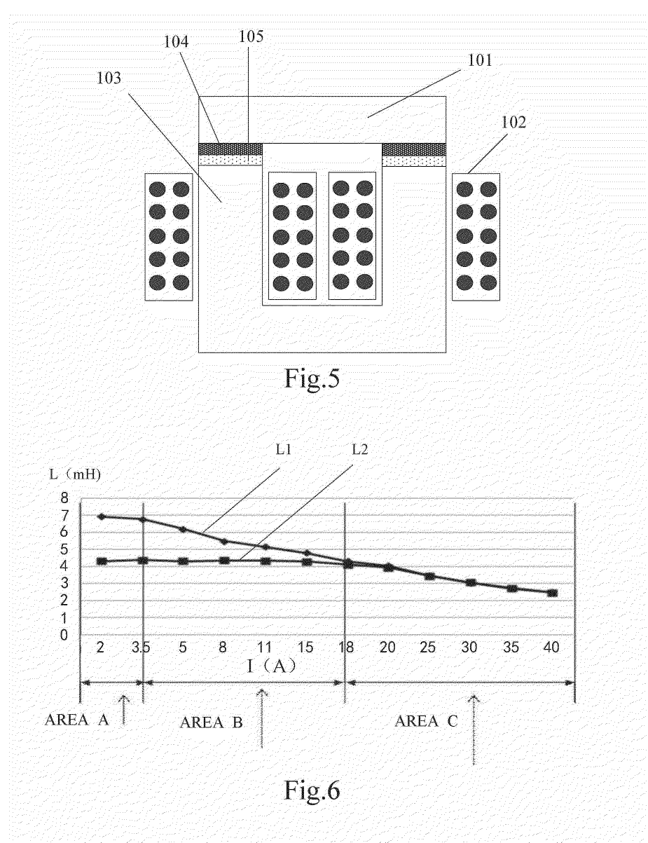

The present embodiment provides an inductor, a schematic side view of which is shown in FIG. 5. The inductor has a UI structure and includes a magnetic core structure composed of a yoke 101 and a limb 103. The yoke 101 and the limb 103 form a closed magnetic path. The limb is a portion of the magnetic core wounded by a winding, and the yoke is a portion of the magnetic core not wounded by the winding. This also applies to following embodiments.

A winding 102 is provided as wounded on the limb 103, and an insulating plate 104 close to the yoke portion and a flat magnetic core unit 105 close to the limb 103 portion are included between the limb 103 and the yoke 101.

A material of the limb 103 and the yoke 101 is a material having a high permeability and a high saturation magnetic flux density (for example, a silicon steel sheet, amorphous or nanocrystalline and so on) which have a relative permeability greater than or equal to 500. A material of the flat magnetic core unit 105 is a material having a high permeability and a low saturation magnetic flux density (for example, manganese zinc ferrite or nickel zinc ferrite) which have a relative permeability equal to or greater than 500 but have a saturation magnetic flux density lower than that of the material of the limb 103 and the yoke 101. In preferable examples, the saturation magnetic flux density of the material having a high permeability and a high saturation magnetic flux density of the limb 103 and the yoke 101 is twice or more of the saturation magnetic flux density of the material having a high permeability and a low saturation magnetic flux density of the flat magnetic core unit 105. In more preferable embodiments, the saturation magnetic flux density of the material of the limb and the yoke is greater than or equal to 1.2 T, and the saturation magnetic flux density of the flat magnetic core unit is less than or equal to 0.6 T.

As shown in FIG. 5, the flat magnetic core unit 105 is provided between two ends of the limb 103 and the yoke. FIG. 5 only shows an example, and the flat magnetic core unit 105 may also be provided only between one end of the limb 103 and the yoke.

The flat magnetic core unit 105 and the insulating plate 104 fill the air gap between the end(s) of the limb 103 and the yoke. In a side view direction, a width of the flat magnetic core unit 105 is the same as a width of an end of the limb 103, and a cross sectional area of the flat magnetic core unit 105 is the same as the cross sectional area of the end of the limb 103. Here, the insulating plate 104 is made of insulating materials which are not conductive and are non-magnetic, for example, glass, ceramic, and foam materials. The insulating materials have a relative permeability of 1. The insulating plate 104 plays a role of supporting. The magnetic core composed of the limb 103 and the yoke 101 as shown in FIG. 5 has a UI type structure. Actually, the magnetic core structure may also have an EI type structure, and the magnetic core may have a three-phase three-limb structure or a three-phase five-limb structure, as long as a material having a high permeability and a low saturation magnetic flux density and an insulating material fill the air gap between the limb and the yoke as the manner provided by the present embodiment.

Firstly, the inductor structure provided by the present embodiment may provide a non-linear inductance. The principles are set forth as follows.

The magnetic path of the inductor is mainly composed of a material of the magnetic core having a high permeability and a high saturation magnetic flux density (the limb 103 and the yoke 101), the magnetic core having a high permeability and a low saturation magnetic flux density (the flat magnetic core unit 105) and an insulating plate 104. The inductance may be approximated by the following formula:

$$L \approx \frac{{μ}_{0} \cdot {N}^{2} \cdot {A}_{e}}{{1}_{g ap} + \frac{{l}_{lowsat}}{k \cdot {μ}_{2}} + \frac{{l}_{total} - {l}_{lowsat} - {1}_{g ap}}{{μ}_{1}}} \qquad ( 1 )$$

In formula (1), meanings of respective parameters are:
N: number of turns of the winding;
μ₀: a vacuum permeability;
μ₁: a relative permeability of the magnetic core having a high permeability and a high saturation magnetic flux density;
μ₂: a relative permeability of the magnetic core having a high permeability and a low saturation magnetic flux density;
Aₑ: a cross sectional area of the limb of the magnetic core having a high permeability and a high saturation magnetic flux density;
k: multiple of the cross sectional area of the magnetic core having a high permeability and a low saturation magnetic flux density with respect to the cross sectional area of the limb of the magnetic core having a high permeability and a high saturation magnetic flux density;
1_{g ap}: a length of the magnetic path in the gap of the insulating plate;
l_{lowsat}: a length of the magnetic path of the magnetic core having a high permeability and a low saturation magnetic flux density;
lₜₒₜₐₗ: a total of the magnetic path of the inductor.

In the case of a light load and small current, all the portions of the magnetic core are not saturated. Since a magnetic resistance of the magnetic core having a high permeability is very small, a magnetic pressure mainly focuses at the insulating plate, at which time the inductance may be expressed as:

$$L \approx \frac{{μ}_{0} \cdot {N}^{2} \cdot {A}_{e}}{{1}_{g ap}} \qquad ( 2 )$$

When the current is increased, the magnetic core having a high permeability and a low saturation magnetic flux density tends to saturate and the magnetic core having a high permeability and a high saturation magnetic flux density is not saturated, the magnetic pressure mainly focuses at the insulating plate and the magnetic core having a high permeability and a low saturation magnetic flux density. At this time, the inductance presents a non-linear decline, and the main influence depends on the declining condition of the permeability μ² of the magnetic core having a high permeability and a low saturation magnetic flux density, and at this time, the inductance may be expressed as:

$$L \approx \frac{{μ}_{0} \cdot {N}^{2} \cdot {A}_{e}}{{1}_{g ap} + \frac{{l}_{lowsat}}{k \cdot {μ}_{2}}} \qquad ( 3 )$$

When the current continues to rise until it reaches a rate current or even a heavy load current, the magnetic core having a high permeability and a low saturation magnetic flux density has been saturated and the magnetic core having a high permeability and a high saturation magnetic flux density starts to saturate, all the materials may be assigned some magnetic pressures, at which time the inductance presents a non-linear decline, and the main influence depends on the declining condition of the permeability of the magnetic core having a high permeability and a high saturation magnetic flux density. At this time, the inductance may be expressed as:

$$L \approx \frac{{μ}_{0} \cdot {N}^{2} \cdot {A}_{e}}{{1}_{g ap} + \frac{{l}_{lowsat}}{k \cdot {μ}_{2}} + \frac{{l}_{total} - {l}_{lowsat} - {1}_{g ap}}{{μ}_{1}}} \qquad ( 4 )$$

It can be seen from comparisons among the formula (2) in the case of a light load and small current, the formula (3) when the current is increased and the formula (4) when the current is increased to a rated current or even a heavy load current that, the inductance is relatively high in the case of a light load and small current, and the inductance gradually goes down as the increase of the current.

FIG. 6 illustrates graphs showing inductance changes of the inductor of the present embodiment and a common inductor versus current changes, in which the inductor of the present embodiment and the common inductor have the same volume. In FIG. 6, L1 is a graph showing the inductance of the inductor structure of the present embodiment versus current changes, L2 is a graph showing the inductance of the common inductor structure versus current changes, area A is a light load and small current area, area B is a current increasing area, and area C is an area where the current continues to rise until it reaches a rated current or even a heavy load current.

It can be seen from FIG. 6 that, in area A (a light load and small current area where all the portions of the magnetic core are not saturated), the inductance of the inductor structure of the present embodiment is far higher than that of the common inductor structure. As the current rises, in area B (the current is between a light load and a heavy load, and the magnetic core having a high permeability and a low saturation magnetic flux density starts to saturate), the inductance of the inductor structure of the present embodiment starts to decline, but is still higher than the inductance of the common inductor. As the current continues to rise, in area C (the current is in a rated area or a heavy load area, the magnetic core having a high permeability and a low saturation magnetic flux density has already been saturated, and the magnetic core having a high permeability and a high saturation magnetic flux density starts to saturate), the inductance graphs L1 and L2 overlap with each other.

Thus, it can be seen that, when the volume is kept unchanged, the inductor structure in the present embodiment may present a high inductance in the case of a light load current to make a light load power supply system have better performance, and even in the case of a rated or even a heavy load current, the inductor structure of the present embodiment still presents performance not worse than the common inductor.

In addition, in the inductor of the present embodiment, a thickness of the flat magnetic core unit 105 may be adjusted. In a preferable embodiment, the thickness of the flat magnetic core unit 105 may be ¼ to ½ of the gap distance between the limb 3 and the yoke 101.

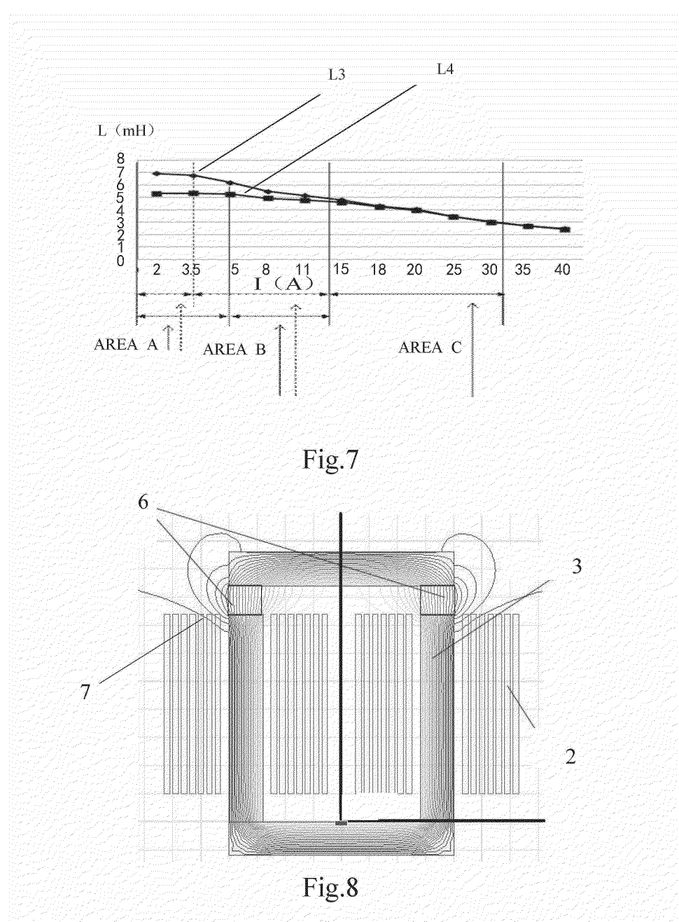

FIG. 7 illustrates graphs showing the inductance of the inductor of the present embodiment versus current changes in the case of different thicknesses of the flat magnetic core unit. L3 is a graph showing the inductance of the inductor versus current changes when the thickness of the flat magnetic core unit 105 is 0.6 mm, L4 is a graph showing the inductance of the inductor versus current changes when the thickness of the flat magnetic core unit 105 is 0.4 mm. It can be seen from FIG. 7 that the larger the thickness of the flat magnetic core unit 105 is, the higher the resulted inductance of the inductor in the case of a light load and small current will be. According to this rule, the thickness of the flat magnetic core unit 105 may be adjusted in order to meet different inductance requirements.

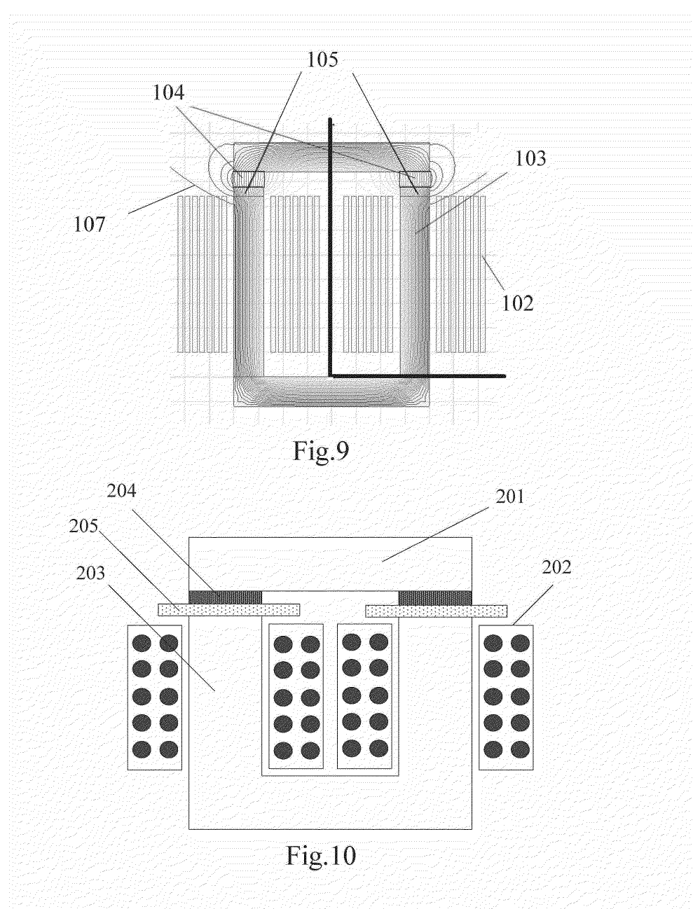

In addition, the inductor structure provided by this embodiment may further reduce eddy-current loss. FIG. 8 is a schematic diagram of a magnetic field line distribution of the common inductor structure as shown in FIG. 4. FIG. 9 is a schematic diagram of a magnetic field line distribution of the inductor structure of the present embodiment as shown in FIG. 5.

From the comparisons between FIGS. 8 and 9, it can be seen that, the magnetic field lines at the second magnetic core 6 (i.e., at the gap between the yoke 1 and the limb 3) in FIG. 8 will spread outward and flow into the winding 2 of coils (as indicated by reference sign 7 in FIG. 8), which will increase the eddy-current loss in the winding 2 of coils; and it can be seen from FIG. 9 that, as compared with FIG. 8, most of the magnetic field lines at the insulating plate 104 and the flat magnetic core unit 105 (i.e., at the gap between the yoke 101 and the limb 103) converge to the flat magnetic core unit 105 and flow into the limb 103 with small parts of the magnetic field lines flowing into the winding 102 of coils, which may effectively reduce the eddy-current loss in the coils in the case of a light load.

In the inductor structure provided by the present embodiment, the flat magnetic core unit is provided between the limb and the yoke, which may provide a non-linear inductance, increase the inductance in the case of a light load when the volume of the inductor is unchanged, and may adjust the thickness of the flat magnetic core unit to obtain required inductance and meanwhile reduce the eddy-current loss in the winding of coils.

### Second Embodiment

The present embodiment provides another inductor structure, a schematic side view of which is shown in FIG. 10.

The inductor has a UI type structure and includes a magnetic core structure composed of a yoke 201 and a limb 203. The yoke 201 and the limb 203 form a closed magnetic path. A winding 202 of coils is provided as wound on the limb 203, an insulating plate 204 close to the yoke 101 portion and a flat magnetic core unit 205 close to the limb 203 portion are included between the limb 203 and the yoke 201.

A material of the magnetic core composed of the limb 203 and the yoke 201 is a material having a high permeability and a high saturation magnetic flux density (for example, a silicon steel sheet, amorphous or nanocrystalline and so on) which have a relative permeability greater than or equal to 500. A material of the flat magnetic core unit 205 is a material having a high permeability and a low saturation magnetic flux density (for example, manganese zinc ferrite or nickel zinc ferrite) which have a relative permeability equal to or greater than 500 but have a saturation magnetic flux density lower than that of the material of the magnetic core composed of the limb 203 and the yoke 201. In preferable embodiments, the saturation magnetic flux density of the material of the magnetic core composed of the limb 203 and the yoke 201 is twice or more of the saturation magnetic flux density of the material of the flat magnetic core unit 205. In more preferable embodiments, the saturation magnetic flux density of the material of the magnetic core composed of the limb 203 and the yoke 201 is greater than or equal to 1.2 T, and the saturation magnetic flux density of the material of the flat magnetic core unit 205 is less than or equal to 0.6 T.

As shown in FIG. 10, the flat magnetic core unit 205 is provided between two ends of the limb 203 and the yoke. FIG. 10 only shows an example, and the flat magnetic core unit 205 may also be provided only between one end of the limb 203 and the yoke.

The flat magnetic core unit 205 and the insulating plate 204 fill the air gap between the end(s) of the limb 203 and the yoke. Here, the insulating plate 204 is made of insulating materials which are not conductive and are non-magnetic, for example, glass, ceramic, and foam materials. The insulating materials have a relative permeability of 1. The insulating plate 204 plays a role of supporting.

The magnetic core composed of the limb 203 and the yoke 201 as shown in FIG. 10 has a UI type structure. Actually, the magnetic core may also have an EI type structure, and the magnetic core may have a three-phase three-limb structure or a three-phase five-limb structure, as long as a material having a high permeability and a low saturation magnetic flux density and an insulating material fill the air gap between the limb and the yoke as the manner provided by the present embodiment.

The inductor structure provided by the present embodiment differs from the inductor structure provided by the first embodiment in that, in a side view direction, a width of the flat magnetic core unit 205 is greater than a width of ends of the limb 203, and a cross sectional area of the flat magnetic core unit 205 is greater than a cross sectional area of the ends of the limb 203, i.e., cross sectional projection of the flat magnetic core unit 205 contains cross sectional projection of the ends of the limb 203. In addition to being capable of providing a non-linear inductance as the inductor structure provided by the first embodiment (specific principles are the same as the first embodiment), the inductor structure in the present embodiment can further reduce the eddy-current loss in the winding of coils.

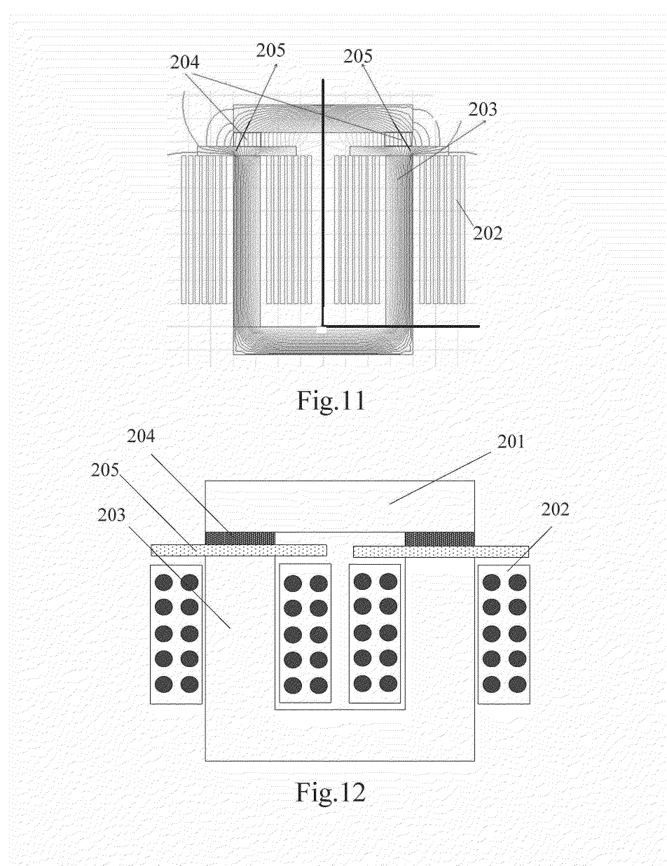

FIG. 11 illustratively shows a schematic diagram of a magnetic field line distribution of the inductor structure of the present embodiment. It can be seen from FIG. 11 that, since the cross sectional area of the magnetic core unit 205 is greater than the cross sectional area of the ends of the limb 203, the magnetic field lines at the insulating plate 204 and the flat magnetic core unit 205 (i.e., at the gap between the yoke 201 and the limb 203) basically converge to the flat magnetic core unit 205 and flow into the limb 203 with small parts of the magnetic field lines flowing into the winding 202 of coils, which may effectively reduce the eddy-current loss in the coils in the case of a light load.

In another preferable example, as shown in FIG. 12, the cross sectional projection of the magnetic core unit may be set as greater than the cross sectional projection of the limb and the winding of coils wounded on the limb, i.e., the cross sectional projection of the flat magnetic core unit 205 contains the cross sectional projection of the ends of the limb 203 and the winding 202 of coils wounded on the limb, which may further effectively avoid that the magnetic field lines flow into the winding 202 of coils, and thereby more effectively reduce the eddy-current loss in the coils in the case of a light load.

In the inductor structure provided by the present embodiment, the flat magnetic core unit is provided between the limb and the yoke, which may provide a non-linear inductance, increase the inductance in the case of a light load when the volume of the inductor is unchanged, and may adjust the thickness of the flat magnetic core unit to obtain required inductance. Meanwhile, that the cross sectional projection of the flat magnetic core unit contains the cross sectional projection of the ends of the limb can more effectively reduce the eddy-current loss in the winding of coils.

### Third Embodiment

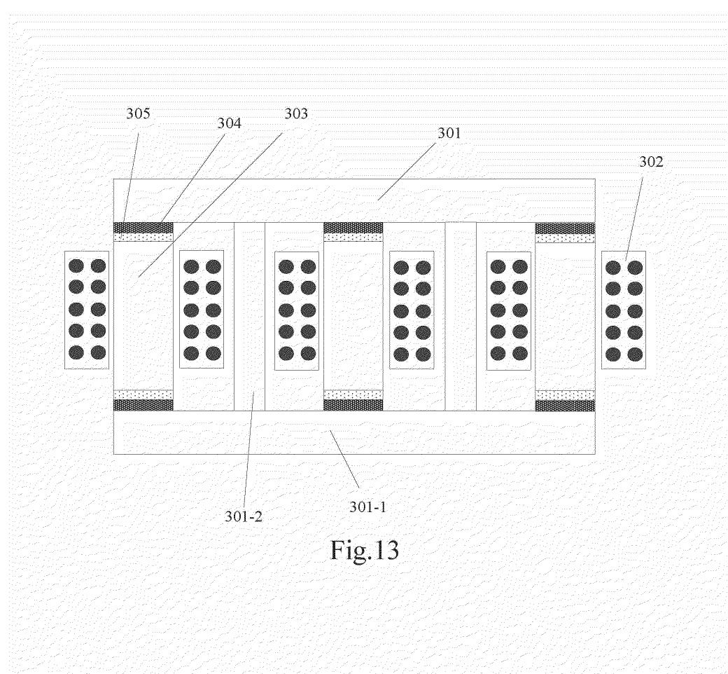

The present embodiment provides another inductor structure, a schematic side view of which is shown in FIG. 13.

The inductor has a three-phase five-limb structure and includes a magnetic core structure composed of at least one yoke and at least one limb. The at least one yoke and the at least one limb form a closed magnetic path. The at least one yoke includes an upper yoke 301, a lower yoke 301-1 and a side yoke 301-2.

A winding 302 of coils is provided as wound on the limb 303, and an insulating plate 304 close to the yoke portion and a flat magnetic core unit 305 close to the limb 303 portion are included between the limb 303 and the upper and lower yokes 301, 301-1. The magnetic core structure in the present embodiment includes three limbs, and the limb 303 is one of the three. The flat magnetic core unit 305 is provided between an upper end of each limb and the upper yoke, and the flat magnetic core unit 305 is provided between a lower end of each limb and the lower yoke.

A material of the magnetic core composed of the limbs and the yokes is a material having a high permeability and a high saturation magnetic flux density (for example, a silicon steel sheet, amorphous or nanocrystalline and so on) which have a relative permeability greater than or equal to 500. A material of the flat magnetic core unit 305 is a material having a high permeability and a low saturation magnetic flux density (for example, manganese zinc ferrite or nickel zinc ferrite) which have a relative permeability equal to or greater than 500 but have a saturation magnetic flux density lower than that of the material of the magnetic core composed of the limbs and the yokes. In preferable embodiments, the saturation magnetic flux density of the material of the magnetic core composed of the limbs and the yokes is twice or more of the saturation magnetic flux density of the material of the flat magnetic core unit 305. In more preferable embodiments, the saturation magnetic flux density of the material of the magnetic core composed of the limb 303 and the yokes is greater than or equal to 1.2 T, and the saturation magnetic flux density of the material of the flat magnetic core unit 305 is less than or equal to 0.6 T.

As shown in FIG. 13, the flat magnetic core unit 305 is provided between upper and lower ends of the three limbs and the upper and lower yokes. FIG. 13 only shows an example, and the flat magnetic core unit 305 may also be provided only between two ends of one or two limbs and the upper and lower yokes, or may be provided only between one end of the limb and any one of the upper and lower yokes. For example, the flat magnetic core unit 305 is provided only between an upper end of the limb and the upper yoke, or is provided between a lower end of the limb and the lower yoke.

The flat magnetic core unit 305 and the insulating plate 304 fill the air gap between the end(s) of the limb 303 and the upper and lower yokes. Here, the insulating plate 304 is made of insulating materials which are not conductive and are non-magnetic, for example, glass, ceramic, and foam materials. The insulating materials have a relative permeability of 1. The insulating plate 304 plays a role of supporting.

The magnetic core composed of the limbs and the yokes as shown in FIG. 13 has a three-phase five-limb structure, and the magnetic core may also have a three-phase three-limb structure, as long as a material having a high permeability and a low saturation magnetic flux density and an insulating material fill the air gap between the limbs and the yokes as the manner provided by the present embodiment.

### Fourth Embodiment

The present embodiment provides a switching circuit in which any one of the inductors provided in the previous embodiments is connected to an input terminal or an output terminal of the switching circuit. The switching circuit may include a rectifying circuit, an inverter circuit or a direct current conversion circuit. Furthermore, the switching circuit may be a single-phase circuit or a three-phase circuit.

It shall be noted that the above descriptions only illustrate preferable embodiments and technology principles of the present disclosure. One of ordinary skill in this art will appreciate that the present disclosure is not limited to the particular embodiments described herein, and one of ordinary skill in this art may make various changes, re-adjustments and substitution without departing from the protection scope of the present disclosure. Thus, although the present disclosure is described in detail with reference to the above embodiments, the present disclosure is not limited to those embodiments, and other equivalent embodiments may be included without departing from the idea of the present disclosure, and the scope of the present disclosure is defined by the scope of the appended claims.

### REFERENCE SIGN LIST

1, 101, 201 yoke
2, 102, 202, 302 winding of coils
3, 103, 203, 303 limb
4 air gap
104, 204, 304 insulating plate
5 step
6 second magnetic core
105, 205, 305 flat magnetic core unit
7, 107 magnetic field line
301 upper yoke
301-1 lower yoke;
301-2 side yoke;
L1 graph showing the inductance of the inductor in the first embodiment versus current changes
L2 graph showing the inductance of the common inductor versus current changes
L3 graph showing the inductance of the inductor in the first embodiment versus current changes when a thickness of the flat magnetic core unit is 0.6 mm
L4 graph showing the inductance of the inductor in the first embodiment when a thickness of the flat magnetic core unit is 0.4 mm

What is claimed is:

1. An inductor, at least comprising a winding, and a magnetic core which comprises one or more limbs and further comprises one or more yokes adapted to form a closed magnetic path, the winding being wounded on the limbs, wherein a gap is provided between at least one end of at least one of the limbs and at least one of the yokes, a flat magnetic core unit is provided in the gap, the flat magnetic core unit is formed of a material having a high permeability and a low saturation magnetic flux density, the limbs and the yokes are formed of a material having a high permeability and a high saturation magnetic flux density, and the saturation magnetic flux density of the material of the flat magnetic core unit is lower than that of the material of the limbs and the yokes.

2. The inductor according to claim 1, wherein the gap is provided between two ends of at least one of the limbs and at least one of the yokes, and the flat magnetic core unit formed of the material having a high permeability and a low saturation magnetic flux density is provided in the gap.

3. The inductor according to claim 1, wherein cross sectional projection of the flat magnetic core unit contains cross sectional projection of an end of at least one of the limbs.

4. The inductor according to claim 1, wherein a cross sectional projection of the flat magnetic core unit contains cross sectional projection of ends of the limbs and the winding.

5. The inductor according to claim 1, wherein the flat magnetic core unit is provided at an end of the gap which is close to at least one of the limbs.

6. The inductor according to claim 1, wherein the flat magnetic core unit is manganese zinc ferrite or nickel zinc ferrite.

7. The inductor according to claim 1, wherein a portion of the gap other than the flat magnetic core unit is filled with an insulating material.

8. The inductor according to claim 1, wherein the materials of the limbs, the yokes and the flat magnetic core unit respectively have a relative permeability greater than or equal to 500.

9. The inductor according to claim 1, wherein the saturation magnetic flux density of the material of the limbs and the yokes is twice or more of the saturation magnetic flux density of the material of the flat magnetic core unit.

10. The inductor according to claim 9, wherein the saturation magnetic flux density of the material of the limbs and the yokes is greater than or equal to 1.2 T, and the saturation magnetic flux density of the material of the flat magnetic core unit is less than or equal to 0.6 T.

11. The inductor according to claim 1, wherein the magnetic core has an EI type structure or a UI type structure.

12. The inductor according to claim 1, wherein the magnetic core has a three-phase three-limb structure or a three-phase five-limb structure.

13. A switching circuit comprising an inductor according to claim 1, wherein the inductor is connected to an input terminal or an output terminal of the switching circuit.

14. The switching circuit according to claim 13, wherein the switching circuit comprises a rectifying circuit, an inverter circuit or a direct current conversion circuit.

15. The switching circuit according to claim 13, wherein the switching circuit comprises a single-phase circuit or a three-phase circuit.
